(19) United States
(12) Patent Application Publication
(10) Pub. No.: US 2026/0153617 A1
(43) Pub. Date: Jun. 4, 2026

(54) SYSTEM AND METHOD FOR GENERATING ECHO TRAILS OF MOVING OBJECTS FOR A SET OF DISPLAY RANGES

(71) Applicant: Furuno Electric Co., Ltd., Nishinomiya-City (JP)

(72) Inventor: Yuito NAKAI, Nishinomiya-City (JP)

(73) Assignee: Furuno Electric Co., Ltd., Nishinomiya-City (JP)

(21) Appl. No.: 19/448,173

(22) Filed: Jan. 14, 2026

Related U.S. Application Data
(63) Continuation of application No. PCT/JP2023/027539, filed on Jul. 27, 2023.

(51) Int. Cl. G01S 13/89; G01S 7/06; G01S 7/41; G06T 11/00

(52) U.S. Cl. CPC G01S 13/89; G01S 7/06; G01S 7/41; G06T 11/00; G06T 2200/24

(57) ABSTRACT

The present disclosure provides a system and method of generating echo trails for a set of display ranges. An antenna receives echo information of source waves at a vessel, from a targeted object. An echo image generator is configured to generate a plurality of processed echo information sets from the received echo information. The received echo information corresponds to a first display range of a display. The plurality of processed echo information sets comprising a plurality of echo trails of the target object is stored in at least one storage. An echo trail of the plurality of echo trails is selected by a selector based on a second display range set by a user. A synthesizer synthesizes a display output based on the selected echo trail.

### CROSS-REFERENCE TO RELATED APPLICATION

This application is a bypass continuation of International Application No. PCT/JP2023/027539, filed on Jul. 27, 2023. The entire contents of the above application are incorporated herein by reference.

### TECHNICAL FIELD

The present disclosure generally relates to object detection techniques and, more particularly relates, to an apparatus and a method for generating echo trails of moving objects for a set of display ranges.

### BACKGROUND

Moving bodies in the marine environment such as vessels, ships, barges, boats, etc. are typically used for the transportation of people and goods among other various applications, across the globe. Apparatuses used in the detection, ranging, and monitoring, such as RAdio Detecting and Ranging (RADAR) and SOund Navigation and Ranging (SONAR) systems, installed on-board the moving bodies or stationary monitoring stations are used to identify moving and stationary objects in a marine environment. Such apparatuses transmit electromagnetic (in RADAR) or sound pressure (in SONAR) waves, sweeping the marine environment for other objects or bodies. The electromagnetic or sound pressure waves are reflected from a target object, for example, a target ship or a vessel. The reflected electromagnetic or sound pressure waves received by the aforementioned apparatuses are called echoes. The echoes are generally considered as signals carrying information about the distance, speed, direction, location, heading, etc. of the target object. Using the echo information, the location, the direction, the translational speed, etc. of the target object can be determined by the concerned apparatuses, such as the RADAR or the SONAR.

The location of the target object may further be displayed with an echo trail on a display screen. The echo trail is a technique used to provide visual representations of motion (for example, path and speed) of surrounding moving bodies by superimposing several received echoes from several respective RADAR or SONAR scans. Information such as the traveling direction and speed of the moving bodies can be obtained and displayed in a substantially real-time environment. The echo trails can be of great assistance to an observer in making real-time assessments of maritime traffic within a predefined vicinity of the observer, whether the observer is on a vessel or a barge, or they are at the stationary monitoring station. The echo trail can either be relative or true. The relative echo trails show relative movement between the observer and the target object. The relative echo trails give an early indication of the collision risk that exists. Further, the relative echo trails when combined with true vectors indicate the relative movement of the target object such as the other vessels. The true echo trails present true target movements depending on the speed and the course of the target object. The duration of the echo trail can be adjusted as per the requirement of the observer. For example, the user can set the period over which the target object needs to be monitored, in other words, the duration of the echo trail to be displayed can be set by the observer. The observer can also set one of the display ranges (e.g. 1.5 NM, 3 NM, 12 NM, etc., where NM represents Nautical Miles) over which the target object needs to be monitored.

However, systems and methods, in the state of the art, for generating and displaying echo trails, suffer from several deficiencies. For instance, when the display range is changed by the observer, it is difficult to judge the echo trails of the newly set display range, as the echo trail may partially disappear or get degraded for a certain period. In that regard, several solutions have been suggested to at least partially address the aforementioned deficiencies. Some of the proposed solutions have been listed below.

For example, a conventional art is introduced in U.S. Pat. No. 7,768,447B2 which discloses methods and apparatuses to process sensing signals. A method includes recording a sensing image sensed at a first detection range and outputting the sensing image to a display. The method further includes recording additional information displayed on a screen and outputting additional information to the display. When the first detection range is or has been changed to a second detection range, a new image from the recorded sensing image is computed using an image manipulation computer function, so that the computed image fits a new scale of the second detection range. The computed image is recorded. The computing changes to the recorded additional information to adjust the additional information to the new scale of the changed range and record the computed additional information. In this method even though the additional information is added to the new scale, degradation and disappearance of the echo trail will occur due to the time involved in processing the additional information. Further, in this method, the trail deteriorates each time when the display area is changed repeatedly. In some cases, the trail becomes discontinuous due to different settings, for example, pulse width, used by different display areas.

FIG. 1A shows a block diagram of processing circuitry 100 for processing echo information 102 in a conventional RADAR apparatus, in accordance with the conventional art. The echo received from a target object (not shown in FIG. 1) is received by an antenna 104 comprises the echo information 102 indicating the distance, speed, direction, location, etc. of the target object. A storage 106 stores the received echo information 102 and the synthesizer 108 synthesizes a display output 110 comprising the echo and the echo trail. The display output 110 is displayed on a display 112. When the observer changes a display parameter such as the display range, a width of the echo trail, a time period of the echo trail, etc., the echo trail would likely have an inconsistent (or discontinuous) width on the display 112. The RADARs are configured to scale (enlarge/shrink) or clear the stored echo trails when a display range is changed by the user. Therefore, degradation in terms of image quality and/or disappearance of portions of the echo trails altogether may occur, making it difficult for the observer to objectively examine the information provided by the echo trails immediately after the display range has been changed.

FIG. 1B illustrates a schematic representation of display output (e.g. 120, 130, 140) comprising an echo trail and an echo in a conventional RADAR apparatus, in accordance with the conventional art. The conventional RADAR apparatus uses an echo trail expansion method to display an echo trail based on the display range set by the user. In this method, the echo trail 122 of the previous set display range will appear along with an echo trail of the newly set display range. The echo trail 122 of the previous set display range will disappear over a period of time. Therefore, due to the simultaneous display of two echo trails, judging the situation of the target object will be difficult until the echo trail 122 of the previous display range disappears. As shown in FIG. 1B, the display output 120 represents an echo trail image having the echo trail 122 and the echo 124 of the target object. The display output 120 corresponds to a current display range in a display. When the user changes the display range to a new display range, there exists degradation and disappearance of echo trail images in the display output 120. For example, when the display range is decreased, as shown in the display output 130, the echo trail images will illustrate a new echo 134 with echo trails 122 and 132. The echo trails 122 and 132 represent the echo trails of the previous display range and the new display range, respectively. When the display range is increased, as shown in the display output 140, the echo trail images will have a new echo 144 with echo trails 122 and 142. The echo trails 122 and 142 represent the echo trails of the previous display range and the new display range, respectively. Thus, instead of displaying the echo and echo trail of the selected display range alone, the echo and echo trail of the previously set display range are also shown on the display. This creates difficulty in tracking and locating the target object.

Therefore, there exists a need for techniques to reduce the occurrences of degradation and disappearance of echo trail images and to make it easier for the observer to judge the situation immediately after the display range is changed, in addition to providing other technical advantages.

### SUMMARY

In order to solve the foregoing problem and to provide other advantages, one aspect of the present disclosure is to provide a method that includes receiving, by an antenna, echo information of a plurality of source waves at a vessel, from a targeted object. The method further includes generating a plurality of processed echo information sets from the received echo information, the received echo information corresponds to a first display range of a display. The method further includes storing the plurality of processed echo information sets. The plurality of processed echo information sets comprises a plurality of echo trails of the target object. The method further includes selecting an echo trail of the plurality of echo trails from the storage based on a second display range set by a user (e.g. observer of the display). The second display range is set from a plurality of predefined display ranges. The method further includes synthesizing a display output based on the selected echo trail.

In an aspect, the method further includes displaying the display output comprising the selected echo trail.

In an aspect, the method further includes accepting the second display range set by the user.

In an aspect, the method further includes setting the second display range by the user comprises changing the first display range to the second display range.

In an aspect, the method further includes processing the echo information to generate the plurality of processed echo information sets for the plurality of predefined display ranges based on the received echo information.

In an aspect, the method further includes generating a processed echo information set from the received echo information for an arbitrary display range.

In an aspect, the method further includes generating a verification dataset comprising the plurality of processed echo information sets and the received echo information.

In an aspect, the method further includes generating the plurality of processed echo information sets by one or more of scaling, filtering, matching, linearly interpolating, and linearly extrapolating the echo information.

In an aspect, a system of generating echo images is disclosed. The system includes an antenna configured to receive echo information of a plurality of source waves at a vessel, from a targeted object. The received echo information corresponds to a first display range of a display. The system also includes an echo image generator configured to generate a plurality of processed echo information sets from the received echo information. The system also includes a storage configured to store the plurality of processed echo information sets. wherein the plurality of processed echo information sets comprises a plurality of echo trails of the target object. The system also includes a selector configured to select an echo trail of the plurality of echo trails from the storage based on a second display range set by a user, the second display range set from a plurality of predefined display ranges. The system also includes a synthesizer configured to synthesize a display output based on the selected echo trail.

In an aspect, the system further includes a display configured to display the display output comprising the selected echo trail.

In an aspect, the system further includes a user interface configured to accept the second display range set by the user.

In an aspect, the user changes the first display range to the second display range.

In an aspect, the echo image generator is further configured to process the echo information to generate the plurality of processed echo information sets for the plurality of predefined display ranges based on the received echo information.

In an aspect, the echo image generator is further configured to generate a processed echo information set from the received echo information for an arbitrary display range.

In an aspect, the synthesizer is further configured to generate a verification dataset comprising the plurality of processed echo information sets and the received echo information.

In an aspect, a system of generating echo images is disclosed. The system includes an antenna configured to receive echo information of a plurality of source waves at a vessel, from a targeted object. The received echo information corresponds to a first display range of a display. The system also includes processing circuitry configured:
to generate a plurality of processed echo information sets from the received echo information,
to store the plurality of processed echo information sets, wherein the plurality of processed echo information sets comprises a plurality of echo trails of the target object,
to select an echo trail of the plurality of echo trails from the storage based on a second display range set by a user, the second display range set from a plurality of predefined display ranges, and
to synthesize a display output based on the selected echo trail.

In an aspect, the system further includes a display configured to display the display output comprising the selected echo trail.

In an aspect, the system further includes a user interface configured to accept the second display range set by the user.

In an aspect, the user changes the first display range to the second display range.

In an aspect, the processing circuitry is further configured to process the echo information to generate the plurality of processed echo information sets for the plurality of predefined display ranges based on the received echo information.

In an aspect, the processing circuitry is further configured to generate a processed echo information set from the received echo information for an arbitrary display range.

In an aspect, the processing circuitry is further configured to generate a verification dataset comprising the plurality of processed echo information sets and the received echo information.

An advantage of various embodiments is to provide a display output that is free from degradation and disappearance of echo trail images when the display range is changed by the user.

The foregoing summary is illustrative only and is not intended to be in any way limiting. In addition to the illustrative aspects, embodiments, and features described above, further aspects, embodiments, and features will become apparent by reference to the drawings and the following detailed description.

The present disclosure provides a system and a method for generating echo trails are disclosed. Echo information received from several RADAR or SONAR scans is used to generate echo trails of target objects, such as surrounding vessels, for several distinct display ranges. The generated echo trails may then be stored in a storage. When a display range is changed from one distinct value to another distinct value, the stored echo trail for the newly set display range value is selected from the stored echo trails and displayed on a display to reduce the occurrences of degradation and disappearance of echo trail images and to make it easier for an observer to monitor the environment in the vicinity of the observer, without a significant delay or latency after the display range is changed. In that regard, the observer may be located on a movable barge or a movable vessel, or the observer may be located at the stationary maritime monitoring station or the like.

### BRIEF DESCRIPTION OF DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those skilled in the art will understand that the drawings are not to scale.

FIG. 1A illustrates a simplified block diagram of processing circuitry for the processing of the echo in a conventional RADAR apparatus, in accordance with conventional art;

FIG. 1B illustrates a schematic representation of the echo and echo in a conventional RADAR apparatus, in accordance with conventional art;

FIG. 2A illustrates an example representation of an environment related to at least some example embodiments of the present disclosure;

FIG. 2B illustrates another example representation of the environment of FIG. 2A related to at least some example embodiments of the present disclosure;

FIG. 3 illustrates a simplified block diagram of the sensing apparatus, in accordance with an embodiment of the present disclosure;

FIG. 4 illustrates a schematic representation of various inputs to processing circuitry of the sensing apparatus, in accordance with an embodiment of the present disclosure;

FIG. 5 illustrates an example representation of a display output showing the marine environment related to at least some example embodiments of the present disclosure;

FIG. 6 illustrates a simplified block diagram of processing circuitry for the processing of the echo in the sensing apparatus, in accordance with an embodiment of the present disclosure;

FIG. 7 illustrates a schematic diagram showing example processes involved in the processing circuitry for the processing of the echo in the sensing apparatus, in accordance with an embodiment of the present disclosure;

FIGS. 8A and 8B illustrate example representations of the display output of the echo in the conventional sensing apparatus;

FIGS. 8C and 8D illustrate example representations of the display output of the echo in the sensing apparatus, in accordance with an embodiment of the present disclosure;

FIGS. 9A and 9B illustrate one another example representations of the display output of the echo in the conventional sensing apparatus;

FIGS. 9C and 9D illustrate one another example representations of the display output of the echo in the sensing apparatus, in accordance with one another embodiment of the present disclosure; and

FIG. 10 illustrates a flow diagram of a method generating echo images, in accordance with an embodiment of the present disclosure.

The drawings referred to in this description are not to be understood as being drawn to scale except if specifically noted, and such drawings are only exemplary in nature.

### DESCRIPTION OF EMBODIMENTS

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments described herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an Application Specific Integrated Circuit (ASIC), a Field Programmable Gate Array (FPGA) or other programmable device that performs logic operations without processing computer-executable instructions. A processor can also be implemented as a combination of computing devices, e.g., a combination of a Digital Signal Processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having an intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

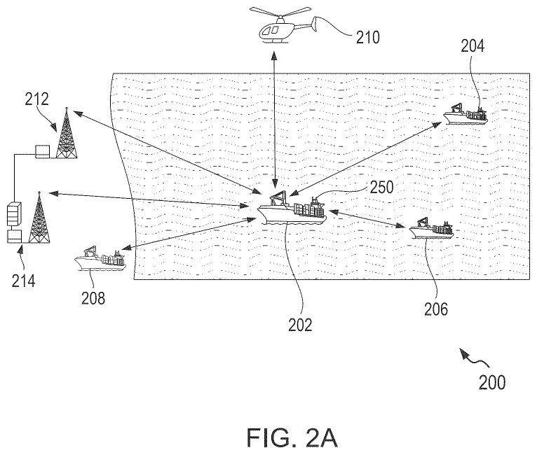

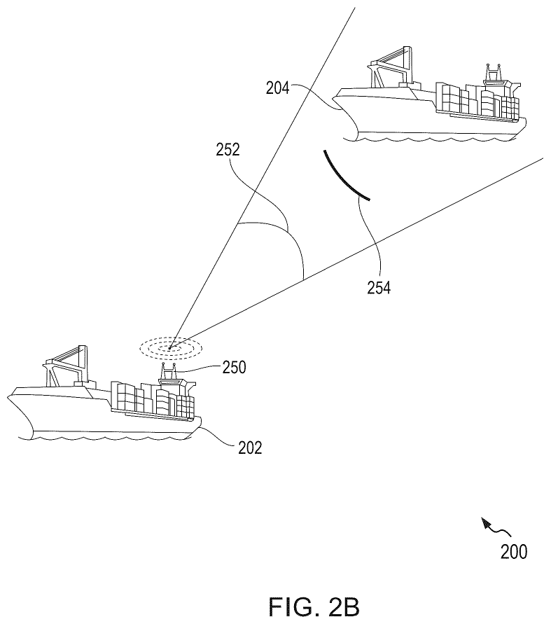

Various embodiments of the present disclosure provide systems and methods for generating echo trails of moving objects for a set of display ranges. A sensing apparatus, such as a radar apparatus or a sonar apparatus, that may be located on-board a vessel or at a stationary monitoring station in a middle of the ocean or at the shore, receives echo information including several echoes from a target object, and performs processing of echo information, for example, scaling, enlarging, shrinking, linearly interpolating, etc. The echo information of the received echoes is processed to generate several processed echo information sets corresponding to several predefined display ranges. The generated processed echo information sets are stored in a storage. When the display range is changed by a user from one value to another, the echo trail stored in the storage for the newly set value of the display range is retrieved from the storage and displayed on the display. This reduces the occurrences of degradation and disappearance of echo trail images due to changes in display ranges, and allows the user to easily evaluate the environment surrounding the vessel without any significant delay or latency after the display range is changed. Various embodiments of the present disclosure are described hereinafter with reference to FIG. 2A to FIG. 10.

It should be noted that the term “echo trails” is interchangeably referred to as “a plurality of echo trails”, “a plurality of potential echo trails”, “a plurality of processed echo information sets”, etc. Similarly, the term “display ranges” are interchangeably referred to as “a set of display ranges”, “a plurality of display ranges”, etc.

FIG. 2A illustrates an example representation of an environment 200 related to at least some example embodiments of the present disclosure. Environment 200 is for example, a marine environment 200 comprising one or more watercraft (e.g., a vessel) configured to sail in water bodies (e.g., sea). Environment 200 includes one or more objects 202, 204, 206, 208, and 210. The environment 200 also includes a communication base station 212 and a communication network station 214. The communication base station 212 and the communication network station 214 are at least wireless connections with each one of one or more objects 202, 204, 206, 208, and 210. In that regard, for generating echo trails any one of the communication base station 212, the communication network station 214, and the one or more objects 202, 204, 206, 208, and 210 may act as an observation station and the rest of the one or more objects 202, 204, 206, 208, and 210 may act as the target objects. For example, if any one of the communication base station 212 and the communication network station 214 acts as an observation station, then all of the one or more objects 204, 206, 208, and 210 will act as the target objects. Alternately, if anyone (for example, a vessel 202) of the one or more objects acts as the observation station, the rest of the one or more objects 202, 204, 206, 208, and 210, i.e., the objects 204, 206, 208, and 210 will act as target objects for generating echo trails. However, the communication base station 212 and the communication network station 214 may not be considered to be target objects as they are envisaged to be stationary locations with respect to an inertial frame of reference.

In that regard, the observation station (for example, the vessel 202) may be equipped with a sensing apparatus 250. The sensing apparatus 250 may be selected from a group consisting RAdio Detecting and Ranging (RADAR) and SOund Navigation and Ranging (SONAR) systems. The sensing apparatus 250 is used to identify moving objects (e.g., vessels 204, 206, and an aircraft 210) and stationary objects (e.g., a vessel 208), and other systems (not shown) in the marine environment.

The vessel 202 may be associated with the communication base station 212 and the communication network station 214. The communication base station 212 and the communication network station 214 can be communicably coupled to the vessel 202 either through wired or wireless communication.

The communication base station 212 serves as a central connection point for a wireless device to communicate. The communication base station 212 has a fixed transceiver and acts as a main communication point for one or more moving objects (e.g., vessels 204, 206, and an aircraft 210), stationary objects (e.g., a vessel 208), and other systems (not shown) in the marine environment 200. The communication base station 212 can have one or more receive/transmit antenna, microwave dish, electronic circuitry, etc., used to handle traffic, such as cellular traffic, data traffic, signal traffic, etc. It serves as a bridge between the communication devices, and systems in the marine environment 200, such as one or more moving objects (e.g., vessels 204, 206, and an aircraft 210), stationary objects (e.g., a vessel 208), and other systems (not shown).

The communication network station 214 connects the communication devices, and systems in the marine environment 200. In marine environment 200, the communication devices, and systems are installed in but not limited to one or more moving objects (e.g., vessels 204, 206, and an aircraft 210), stationary objects (e.g., a vessel 208), and other systems (not shown). In one embodiment, the communication devices, and systems in the marine environment 200 include apparatuses used in the detection, ranging, and monitoring, such as RADAR and SONAR systems, installed on-board the moving bodies or stationary monitoring stations. The communication usually happens through wireless means, such as a radio channel in telecommunications and computer networking. The communication network station 214 is used for information transfer of, for example, a digital bit stream, from one or several senders to one or several receivers. The communication network station 214 has a certain capacity for transmitting information, often measured by its bandwidth in Hz or its data rate in bits per second.

The sensing apparatus 250 and other communication devices and systems in the marine environment 200 communicate with each other and also with the communication base station 212 using the communication network station 214. In some embodiments, the communication network station 214 acts as a Dual Function RADAR communication Base Station (DFBS). In the DFBS system, the communication base station 212 functions both as the central connection point for the wireless device to communicate and also acts as sensing apparatus, for example, RADAR, to receive echo signals reflected from the targets.

The sensing apparatus 250 may include one or more components configured to detect target objects (either in the static or dynamic state) present within a predetermined display range of the vessel 202 (acting as the observation station) and determine one or more parameters associated with the detected target object 204. One or more parameters associated with the detected target object 204 are not limited to position information, traveling information, direction, and velocity.

FIG. 2B illustrates another example representation of the environment 200 of FIG. 2A related to at least some example embodiments of the present disclosure. The sensing apparatus 250 transmits a plurality of source waves 252 through several full circle (360 degree) sweeps. The plurality of source waves 252 reach the one or more target objects 204, 206, 208, and 210 and are reflected from the one or more target objects 204, 206, 208, and 210. The reflected waves correspond to the plurality of source waves 252, referred to as, for example, the echoes 254 are received by the vessel 202 from the target object 204.

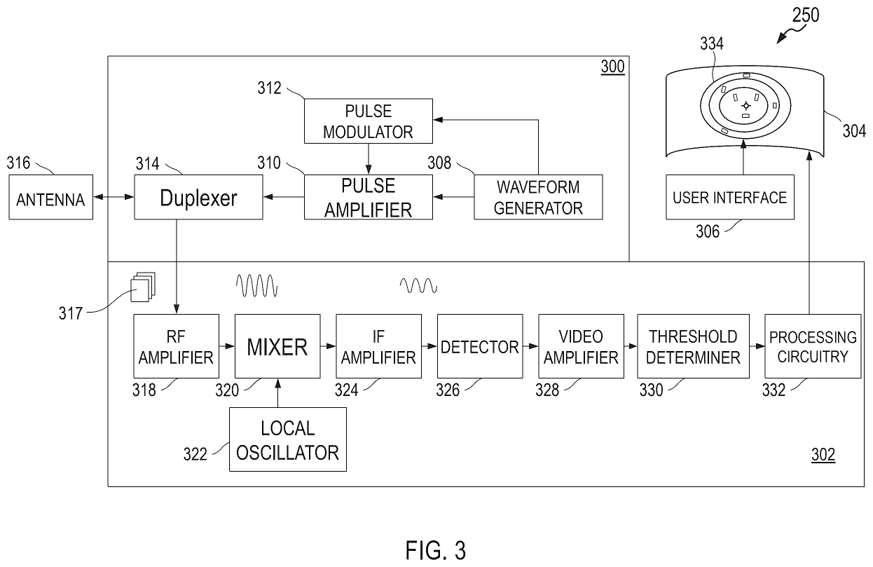

FIG. 3 illustrates a simplified block diagram of the sensing apparatus 250, in accordance with an embodiment of the present disclosure. The sensing apparatus 250 has a transmitter 300, a receiver 302, the display 304, and a User Interface (UI) 306. The transmitter 300 can be one of, but not limited to a magnetron, a traveling wave tube, or a transistor amplifier.

The transmitter 300 has a waveform generator 308 for generating a low-power source signal (for example, radio waves) (e.g., source waves 252). The source waves 252 are transmitted from the observation station (for example, the vessel 202) for detecting a target object, (for example, the target vessel 204). The signal generated by the waveform generator 308 is fed to a pulse amplifier 310. In the case of a pulse RADAR, magnetrons are widely used as transmitters but whenever there exists a need for high average power then the pulse amplifier 310 can be used.

The transmitter 300 also has a pulse modulator 312. The pulse modulator 312 turns ON and OFF the pulse amplifier 310, according to the input pulses generated by the waveform generator 308. A duplexer 314 is used to form isolation between the transmitter 300 and the receiver 302. The transmission of the source waves 252 by the transmitter 300 and reception of echo 254 by the receiver 302 can be done using a single antenna 316, as shown in FIG. 3. The duplexer 314 allows the use of the single antenna 316 for both transmission and reception purposes. As the transmitter 300 and the receiver 302 operate at different power levels, the duplexer 314 isolates the transmitter 300 and the receiver 302. Thus, the signal from the pulse amplifier 310 is provided to the antenna 316 through the duplexer 314.

The antenna 316 also receives the echoes 254 from the one or more target objects 204, 206, 208, and 210. Information that can be extracted from echoes 254, referred to as echo information 317, may include locations, directions, and speeds of the one or more target objects 204, 206, 208. Using the echo information 317, the location, direction, and speed of the target object 204 can be calculated by the sensing apparatus 250.

An example of the receiver 302 is a superheterodyne receiver. The superheterodyne receiver is a type of radio receiver that uses frequency mixing to convert the echo 254 to a fixed Intermediate Frequency (IF) signal which can be more conveniently processed than an original carrier frequency. The receiver 302 has a Radio Frequency (RF) amplifier 318 (e.g. low noise RF amplifier). The RF amplifier 318 acts as the input stage for the receiver 302. The RF amplifier 318 generates an RF pulse which is proportional to the echo 254 of the source waves 252. In one embodiment, the RF amplifier 318 acts at the input stage of the receiver 302. In one another embodiment, a mixer 320 acts at the input stage by eliminating the RF amplifier 318. The mixer 320 mixes the output of the RF amplifier 318 and the output of a local oscillator 322 and the output of the mixer 320 is fed into the IF amplifier 324. In IF amplifier 324, the RF pulse received from the mixer 320 is converted into an IF signal. The IF signal generated by the mixer 320 is amplified by the IF amplifier 324. The IF amplifier 324 acts as a matched filter and increases the Signal to Noise Ratio (SNR) of the echo 254. Also, it enhances the echo-detecting ability of the receiver 302 by reducing the effects of unwanted signals. The bandwidth of the receiver 302 is associated with the bandwidth of the IF amplifier 324.

The receiver 302 also has a detector 326 (e.g. a crystal diode) to perform demodulation of the echo 254 by separating the source waves 252 from a carrier. A video amplifier 328 amplifies the echo 254 to a level that can be displayed on the display 304. In one embodiment of the invention, the detector 326 and the video amplifier 328 are replaced with an Analog to Digital (AD) converter. The AD converter performs digital signal processing of the IF signal. A threshold determiner 330 decides the existence of the target object 204 in the marine environment 200. The threshold determiner 330 is set with a threshold value that is compared with the magnitude of the source waves 252. If the threshold value is surpassed by the threshold determiner 330, then this shows the presence of the target object 204. Otherwise, it is assumed that only the noise component is present in the waves received by the antenna 316.

The display 304 shows a display output 334 of the receiver 302. The range and location of the target object 204 are displayed on the display 304, by mapping it in polar coordinates. In one embodiment, the display 304 is implemented with a Plan Position Indicator (PPI) implemented with Cathode Ray Tube (CRT). The display output 334 modulates the electron beam of the CRT to permit the electron beam to sweep from the center in the outward direction of the CRT. The sweep represents a rotation in synchronization with the pointing of the antenna 316.

The antenna 316 acts as a transceiver for transmitting source waves 252 around the vessel 202. The antenna 316 also receives the echo 254 from the target object 204. Processing circuitry 332 processes the received echo 254 and sends the echo information 317 (e.g. location, direction, speed of target object), to the display 304 in the form of echo images. The sensing apparatus 250 also has the UI 306 for allowing a user to input display parameters. In one embodiment, the UI 306 allows the user to change the display range to an arbitrary value, or a predefined and configured display range of the current echo trial in the display 304.

The sensing apparatus 250 processes the received echoes 254 of a currently-set display range and generates a plurality of potential echo trails for each configurable range (also referred to as a “plurality of display ranges”). The plurality of potential echo trails for each configurable range is stored in a storage (not shown in FIG. 2B).

A user can select using the UI 306 a display range from the plurality of display ranges. Based on the display parameter (i.e., display range) set by the user, the display output of the target object 204 is adjusted in the display 304. The plurality of display ranges is a set of display ranges that can be configured using the sensing apparatus 250. An example of the plurality of display range is not limited to, a plurality of display ranges, such as 12 NM, 3 NM, and 1.5 NM. Based on the selected display range, the display output (e.g., echo and echo trail) of the targeted object is displayed on the display 304.

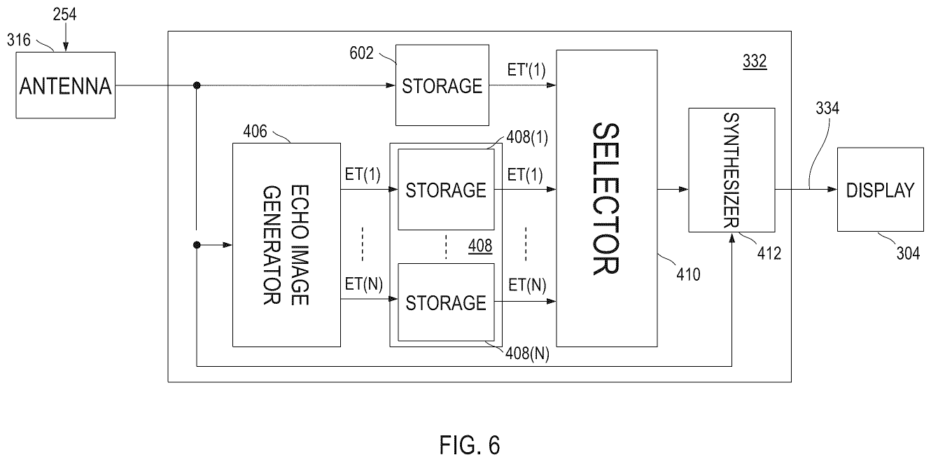

In one embodiment of the invention, the processing circuitry 332 generates a plurality of processed echo information sets from the received echo information 317. The received echo information 317 corresponds to a first display range of the current echo trial in the display 304. The first display range represents the current display range of the echo trial in the display 304. The user, using the UI 306 can change the display range by selecting a new display range from the plurality of display ranges. The new display range selected by the user represents a second display range. That is the user using the UI 306 changes the display range from the first display range to the second display range. The detailed steps of processing of echo by the processing circuitry 332 are depicted in FIG. 6.

The sensing apparatus 250 is configured to locate the objects (e.g., the target vessels 204, 206, 208, and 210) present within the predetermined area of the vessel 202 based on receipt of the reflected source waves (e.g. echo 254) being intercepted by the target vessels (e.g., the target vessels 204, 206, 208, and 210). Moreover, the sensing apparatus 250 is configured to determine the coordinates of the target vessels (e.g., the target vessels 204, 206, 208, and 210) and the distance between the vessel 202 and each of the target vessels (e.g., the target vessels 204, 206, 208, and 210). The distance between the vessel 202 and the target vessels (e.g., the target vessels 204, 206, 208, and 210) is computed based on the time measured between the transmission of the source waves 252 and receipt of the echo 254. From the received echo 254, echo information 317 such as locations, directions, and speeds of the one or more target objects (e.g., the target vessels 204, 206, 208, and 210) can be extracted by the sensing apparatus 250. More specifically, the processing circuitry 332 is capable of processing the echo 254 and extracting locations, directions, and speeds of the one or more target objects (e.g., the target vessels 204, 206, 208, and 210) from the echo 254.

The processing circuitry is further configured to generate a plurality of processed echo information sets from the received echo 254. The received echo 254 corresponds to a first display range of the current echo trial in the display 304. The plurality of processed echo information sets comprising a plurality of echo trails of the target object (e.g. vessel 204) is stored in at least one storage (not shown in FIG. 3). An echo trail of the plurality of echo trails is selected by a selector (not shown in FIG. 3) based on a second display range set by a user. A synthesizer (not shown in FIG. 3) synthesizes the display output 334 based on the selected echo trail. When a display range is changed from one distinct value to another distinct value, the stored echo trail for the newly set display range value is selected from the stored echo trails and displayed on the display 304. This reduces the occurrences of degradation and disappearance of echo trail images displayed on the display 304.

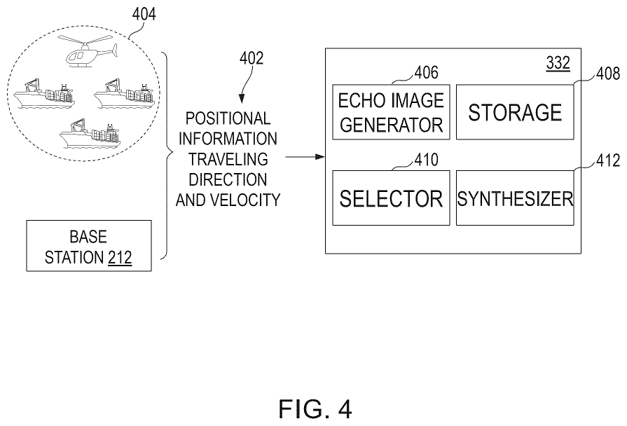

FIG. 4 illustrates a schematic representation of various inputs 402 (e.g., position information, traveling information, direction, and velocity) to the processing circuitry 332 of the sensing apparatus 250, in accordance with an embodiment of the present disclosure. The echo information 317 is received by the sensing apparatus 250 of the vessel 202 from a plurality of target objects 404 (e.g., moving vessels 204, 206, stationary vessel 208, and aircraft 210). The sensing apparatus 250 also receives data from or sends data to the communication base station 212. The echo information 317 includes but is not limited to inputs 402 of one or more of the target objects (204, 206, 208, or 210). The processing circuitry 332 has an echo image generator 406, a storage 408, a selector 410, and a synthesizer 412.

The echo image generator is configured to generate a plurality of processed echo information sets from the received echo 254. The received echo 254 corresponds to a first display range of the current echo trial in the display 304. The plurality of processed echo information sets comprising a plurality of echo trails of the target object (e.g. 204) is stored in at least one storage 408. The echo trail of the plurality of echo trails is selected by a selector 410 based on the second display range set by the user. The synthesizer 412 synthesizes the display output 334 based on the selected echo trail. The synthesizer 412 generates a verification dataset comprising the plurality of processed echo information sets and the received echo information 317.

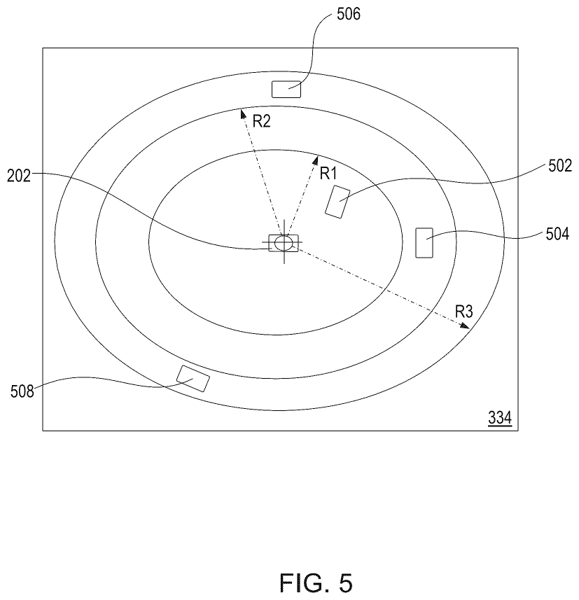

FIG. 5 illustrates an example representation of the display output 334 showing the marine environment 200 related to at least some example embodiments of the present disclosure. As shown in the FIG. 5, the vessel 202 is positioned in the center of the display output 334. The vessel 202 transmits the source waves 252 around it. In one embodiment, the display 304 can be configured in three display ranges, for example, Range R1, Range R2, and Range R3. The various vessels 502, 504, 506, and 508 (also referred to as “target objects 502, 504, 506, and 508”) are also shown in FIG. 3. The vessel 502 is within the display range R1, the vessel 504 is within the display range R2 and the vessels 506 and 508 are within the display range R3. The user may set the display range, for example, from the current display range (also referred to as the “first display range”) to the new display range (also referred to as the “second display range”). For example, if the first display range is R2, the user can change the display range from R2 to R1 or R3. R1, R2, and R3 can be not limited to 1.5 NM, 3 NM, and 12 NM respectively. The pulse width and the current display range should be set by the user in such a way as to clearly view the echo and echo trials of the target object, on the display 304. One embodiment of the invention, allows the user to set or change a pulse width for each display range, using the UI 306. In one embodiment of the invention, the current pulse width set by the user can be stored in a storage and the echo image generator may generate the plurality of processed echo information sets corresponding to the pulse width stored in the storage.

It should be noted that, if the display range is small, for example, 1.5 NM, the corresponding echo and echo trail will appear large on the display 304. On the other hand, if the display range is large, for example, 12 NM, the corresponding echo and echo trail will appear small on the display 304.

FIG. 6 illustrates a simplified block diagram of the processing circuitry 332 for the processing of the echo information 317 in the sensing apparatus 250, in accordance with an embodiment of the present disclosure. It should be noted that for simplicity the processing of the echo information 317 in the receiver 302 is omitted and FIG. 6 mainly describes about the processing of the echo information 317 in the processing circuitry 332. The processing circuitry 332 has an echo image generator 406 for processing the echo information 317 received by the antenna 316. The echo image generator generates a plurality of processed echo information sets from the received echo information 317. The processed echo information sets represent a plurality of echo trails ET(1), ET(2) . . . ET(N) (where N is the integer) and each corresponds to the plurality of the display range of the current echo trial in the display 304. The plurality of echo trails ET(1), ET(2) . . . ET(N) is generated based on the received echo information 317. Thus, depending on the configuration of at least the sensing apparatus 250 and setting in the display 304, the plurality of echo trails ET(1), ET(2) . . . ET(N) of the target object 204 is generated by the echo image generator.

The processing circuitry 332 has one or more storages, for example, storage 602 and the plurality of storage 408 (also referred to as “storages 408”). The storage 602 stores the echo trial ET′(1) corresponding to the current display range, that is, the first display range. The plurality of storages 408 can be, for example, storages 408(1), 408(2) . . . 408(N) (where N is an integer). The echo image generator generates the plurality of echo trails ET(1), ET(2) . . . ET(N) for each display range based on the received echo information 317. Each of the generated plurality of echo trails ET(1), ET(2) . . . ET(N) of the target object 204 is stored in respective storages 408(1), 408(2), . . . 408(N).

When the user changes the display range, that is from the first display range to the second display range, using the UI 306, the corresponding echo trail (one of the echo trails ET(1), ET(2) . . . ET(N)) stored in the corresponding storage 408(1), 408(2) . . . 408(N) is selected by a selector 410. The echo trail (one of the echo trails ET(1), ET(2) . . . ET(N)) selected based on the second display range (that is, the newly set display range) is displayed as the display output 334 on the display 304.

It should be noted that the plurality of display ranges is predefined depending on the device specification of at least one of the sensing apparatus 250 and the display 304. The device specification is not limited to the working range of sensing apparatus 250, the processing speed of the processing circuitry 332 and an echo image generator 406, the frequency of the source wave from the waveform generator 308, etc.

A synthesizer 412 displays the display output 334 based on the selected echo trail. It should be noted that the display output 334 comprises the echo information 317 and the echo trail selected based on the new display range. Thus, the delay, degradation, and disappearance of the echo trail at the time of changing the display range (for example, from the first display range to the second display range) can be avoided, as the echo trail of the selected display range is already stored in the storage 408(1), 408(2) . . . 408(N) and the same can be easily retrieved and displayed on the display 304.

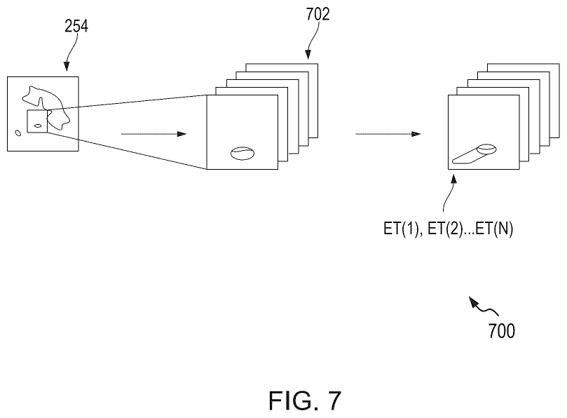

FIG. 7 illustrates a schematic diagram showing example processes 700 involved in the processing circuitry 332 for the processing of the echoes 254 in the sensing apparatus 250, in accordance with an embodiment of the present disclosure. From the echo information 317 (obtained from the echo 254) received from the target object (e.g. 204), the processing circuitry 332 processes a plurality of echo information 702 for each display range. The plurality of echo information 702 for all the display ranges is generated by the processing circuitry 332 from the received echo information 317. As the echo trails ET(1), ET(2) . . . ET(N) for all the display ranges for the received echo trail is readily available in the respective storage 408(1), 408(2) . . . 408(N), the echo trail of user selected display range is immediately shown on the display 304 without delay. This reduces the occurrences of degradation and disappearance of echo trail images and makes it easier to judge the situation immediately after the display range is changed.

Some of the processing performed by the echo image generator for each configurable display range is not limited to:
Echo scaling: This includes enlarging or shrunken the echoes for each configurable display range;
Image filtering: To smooth the echo after echo scaling; and
Echo size processing: To match the corresponding pulse width set per display range
Echo size processing may include without limitation, linear interpolation and linear extrapolation. Linear interpolation is a method useful for building new data points within the range of a discrete set of already-known data points. Thus, a new display range between the known display ranges can be found using linear interpolation. Linear extrapolation creates a tangent line at the end of the known data and extends it beyond that limit. Thus, a new display range beyond known display ranges can be found using linear extrapolation. This allows the sensing apparatus 250 to be operated in more configurable, predefined display ranges.

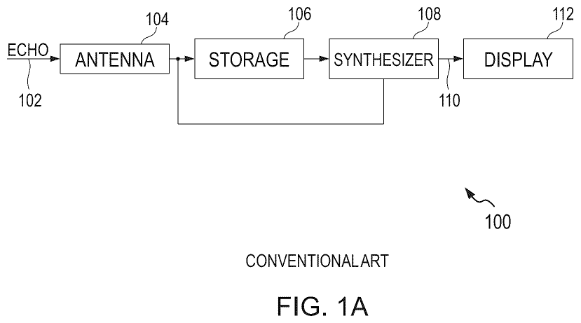

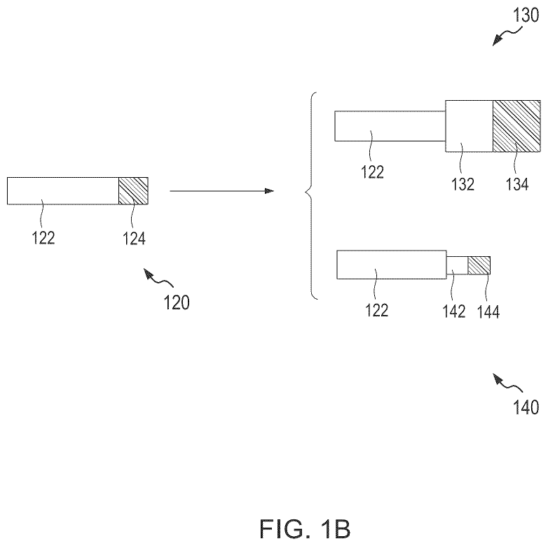

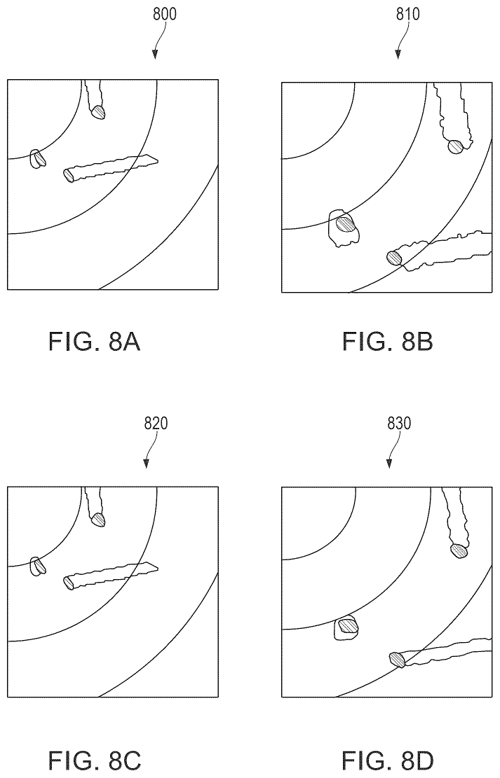

FIGS. 8A and 8B illustrate example representations of the display outputs 800 and 810 of the echo trail in the conventional sensing apparatus. The conventional sensing apparatus uses the echo trail expansion method (refer to FIG. 1B) when the display range is changed by the user. In FIGS. 8A and 8B, the display range is changed from 6 NM to 3 NM. The display output 800 represents the echo trail at the display range of 6 NM. The display output 810 represents the echo trail at the display range of 3 NM (after changing from 6 NM). It is evident that there exists the degradation of echo trail images and this makes it harder for the observer to judge the situation of the target object immediately after the display range is changed.

FIGS. 8C and 8D illustrate example representations of the display outputs 820 and 830 of the echo in the sensing apparatus 250, in accordance with an embodiment of the present disclosure. In FIGS. 8C and 8D, the display range is changed from 6 NM to 3 NM. The display output 820 represents the echo trail at the display range of 6 NM. The display output 830 represents the echo trail at the display range of 3 NM (after changing from 6 NM). It should be noted that using the present invention, the echo trial of the previously set display range (i.e. 6 NM) will be cleared completely and the echo trial of the newly set display range (i.e. 3 NM) will be displayed on the display 304 by selecting the already pre-stored echo trial corresponding to the newly set display range, from the storage 408. It is evident that there exists no degradation and disappearance of echo trail images and this makes it easier for the observer to judge the situation of the target object immediately after the display range is changed compared to the display outputs 800 and 810 in FIGS. 8A and 8B.

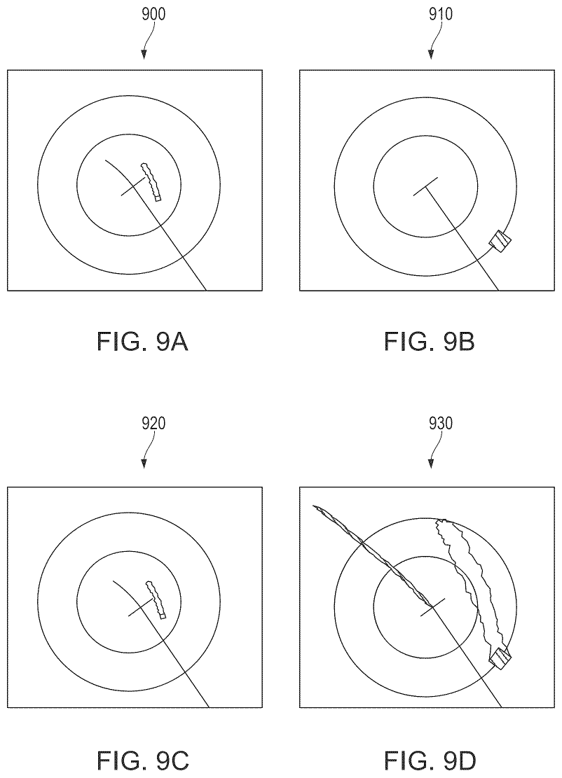

FIGS. 9A and 9B illustrate example representations of the display outputs 900 and 910 of the echo in the conventional sensing apparatus. The conventional sensing apparatus uses the echo trail expansion method (Refer to FIG. 1B) when the display range is changed by the user. The display range is changed from 12 NM to 3 NM. The display output 900 represents the echo trail at the display range of 12 NM. The display output 910 represents the echo trail at the display range of 3 NM (after changing from 12 NM). It is evident that there exists the disappearance of echo trail images and this makes it harder for the observer to judge the situation of the target object immediately after the display range is changed.

FIGS. 9C and 9D illustrate example representations of the display outputs 920 and 930 of the echo in the sensing apparatus 250, in accordance with another embodiment of the present disclosure. The display range is changed from 12 NM to 3 NM. The display output 920 represents the echo trail at the display range of 12 NM. The display output 930 represents the echo trail at the display range of 3 NM (after changing from 12 NM). It should be noted that using the present invention, the echo trial of the previously set display range (i.e. 12 NM) will be cleared completely and the echo trial of the newly set display range (i.e. 3 NM) will be displayed on the display 304 by selecting the already pre-stored echo trial corresponding to the newly set display range, from the storage 408. It is evident that there exists no disappearance of echo trail images and this makes it easier for the observer to judge the situation of the target object immediately after the display range is changed compared to the display outputs 900 and 910 in FIGS. 9A and 9B.

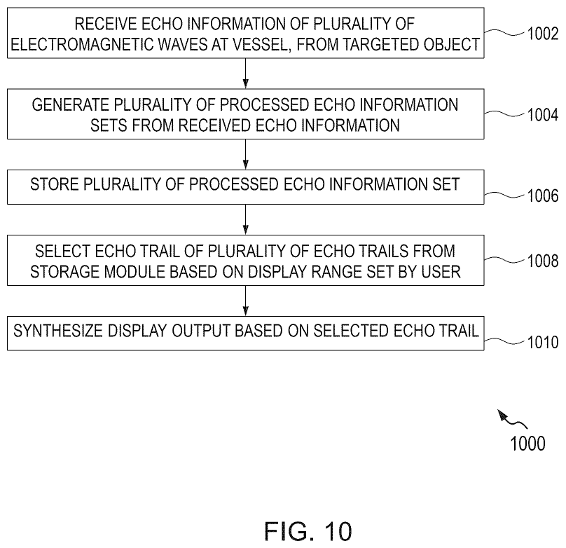

FIG. 10 illustrates a flow diagram of a method 1000 generating echo images, in accordance with an embodiment of the present disclosure. Operations of the flow diagram of the method 1000, and combinations of the operations in the flow diagram of the method 1000, may be implemented by, for example, hardware, firmware, processing circuitry, and/or a different device associated with the execution of software that includes one or more computer program instructions. The sequence of operations of the method 1000 may not be necessarily executed in the same order as they are presented. Further, one or more operations may be grouped and performed in the form of a single step, or one operation may have several sub-steps that may be performed in a parallel or a sequential manner. The method 1000 starts at operation 1002.

At operation 1002, the method 1000 includes receiving, by the antenna 316, echo information 317 of the plurality of source waves 252 at the vessel 202, from the targeted object 204.

At operation 1004, the method 1000 includes generating, by the echo image generator, the plurality of processed echo information sets from the received echo information, the received echo information corresponds to a first display range of a display 304. The display 304 displays the display output 334 comprising the selected echo trail.

The echo image generator processes the echo information 317 to generate the plurality of processed echo information sets for the plurality of predefined display ranges based on the received echo information 317.

In one embodiment the echo image generator processes the processed echo information set from the received echo information 317 for an arbitrary display range. The arbitrary display range can be set by the user or predefined by the user.

In another embodiment generating the plurality of processed echo information sets comprises one or more of scaling, filtering, matching, linearly interpolating, and linearly extrapolating the echo information 317.

At operation 1006, the method 1000 includes storing, by the storage 602, 408, the plurality of processed echo information sets, wherein the plurality of processed echo information sets comprises the plurality of echo trails ET(1), ET(2) . . . ET(N) of the target object 204.

At operation 1008, the method 1000 includes selecting, by the selector 410, an echo trail of the plurality of echo trails ET(1), ET(2) . . . ET(N) from the storage 602, 408 based on a second display range set by the user, the second display range set from a plurality of predefined display ranges. The observer using the user interface 306 can change from the first display range to the second display range. The selector 410 selects the echo trial of the newly set display range from the plurality of echo trails ET(1), ET(2) . . . ET(N).

At operation 1010, the method 1000 includes synthesizing, by the synthesizer 412, the display output 334 based on the selected echo trail. The echo and echo trial of the newly set display range is synthesized and displayed to the observer on the display 304. In one embodiment, a verification dataset comprising the plurality of processed echo information sets and the received echo information 317 is generated by the processing circuitry or the echo image generator.

The disclosed methods with reference to FIG. 10, or one or more operations of the sensing apparatus 250 may be implemented using software including computer-executable instructions or machine-readable instructions stored on one or more computer-readable media (e.g., non-transitory computer-readable media, such as one or more optical media discs, volatile memory components (e.g., Dynamic Random Access Memory (DRAM) or Static Random Access Memory (SRAM)), or non-volatile memory or storage components (e.g., hard drives or solid-state non-volatile memory components, such as Flash memory components)) and executed on a computer (e.g., any suitable computer, such as a Multi-Function Device (MFD), Multi-Function Device Black Box (MFD-BB), a navigation device, a chart plotter, Electronic Chart Display And Information System (ECDIS), a laptop computer, netbook, Webbook, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web (WWW), an intranet, software applications, cable (including fiber optic cable), magnetic communications, source communications (including Radio Frequency (RF), microwave, and infrared communications), electronic communications, or other such communication means.

Although the present disclosure has been described with reference to specific exemplary embodiments, it is noted that various modifications and changes may be made to these embodiments without departing from the broad spirit and scope of the present disclosure. For example, the various operations, blocks, etc., described herein may be enabled and operated using hardware circuitry (for example, Complementary Metal-Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the echo image generator among other components of the sensing apparatus 250 may be enabled using software and/or using transistors, logic gates, and electrical circuits (for example, integrated circuit circuitry such as ASIC circuitry). Various embodiments of the present disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read-Only Memory (CD-ROM), Compact Disc Recordable (CD-R), Compact Disc Rewritable (CD-R/W), Digital Versatile Disc (DVD), BD (BLU-RAY(R) Disc), and semiconductor memories (such as mask ROM, programmable ROM (PROM), Erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and source waves. Transitory computer-readable media can provide the program to a computer via a wired communication line (e.g., electric wires, and optical fibers) or a wireless communication line.

Thus, the echo image generator allows no degradation and disappearance of echo trail images when the display range is changed by the user. Further, the present invention allows the observer to easily judge the situation of the target object immediately after the display range.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the scope of the disclosure.

What is claimed is:

1. A method of generating echo images, comprising:
receiving echo information of a plurality of source waves at a vessel, from a targeted object;
generating a plurality of processed echo information sets from the received echo information, wherein the received echo information corresponds to a first display range of a display;
storing the plurality of processed echo information sets, wherein the plurality of processed echo information sets comprises a plurality of echo trails of the target object;
selecting an echo trail of the plurality of echo trails from the storage based on a second display range set by a user, the second display range set from a plurality of predefined display ranges; and
synthesizing a display output based on the selected echo trail.

2. The method of claim 1, further comprising:
displaying the display output comprising the selected echo trail.

3. The method of claim 1, further comprising:
accepting the second display range set by the user.

4. The method of claim 3, wherein:
setting the second display range by the user comprises changing the first display range to the second display range.

5. The method of claim 1, further comprising:
processing the echo information to generate the plurality of processed echo information sets for the plurality of predefined display ranges based on the received echo information.

6. The method of claim 5, further comprising:
generating a processed echo information set from the received echo information for an arbitrary display range.

7. The method of claim 1, further comprising:
generating a verification dataset comprising the plurality of processed echo information sets and the received echo information.

8. The method of claim 1, wherein:
generating the plurality of processed echo information sets comprises one or more of scaling, filtering, matching, linearly interpolating, and linearly extrapolating the echo information.

9. A system of generating echo images, comprising:
an antenna configured to receive echo information of a plurality of source waves at a vessel, from a targeted object, the received echo information corresponds to a first display range of a display;
an echo image generator configured to generate a plurality of processed echo information sets from the received echo information;
a storage configured to store the plurality of processed echo information sets, wherein the plurality of processed echo information sets comprises a plurality of echo trails of the target object;
a selector configured to select an echo trail of the plurality of echo trails from the storage based on a second display range set by a user, the second display range set from a plurality of predefined display ranges; and
a synthesizer configured to synthesize a display output based on the selected echo trail.

10. The system of claim 9, further comprising:
a display configured to display the display output comprising the selected echo trail.

11. The system of claim 9, further comprising:
a user interface configured to accept the second display range set by the user.

12. The system of claim 9, wherein:
the echo image generator is further configured to process the echo information to generate the plurality of processed echo information sets for the plurality of predefined display ranges based on the received echo information.

13. The system of claim 12, wherein:
the echo image generator is further configured to generate a processed echo information set from the received echo information for an arbitrary display range.

14. The system of claim 9, wherein:
the synthesizer is further configured to generate a verification dataset comprising the plurality of processed echo information sets and the received echo information.

15. A system of generating echo images, comprising:
an antenna configured to receive echo information of a plurality of source waves at a vessel, from a targeted object, the received echo information corresponds to a first display range of a display;
processing circuitry configured
to generate a plurality of processed echo information sets from the received echo information;
to store the plurality of processed echo information sets, wherein the plurality of processed echo information sets comprises a plurality of echo trails of the target object;
to select an echo trail of the plurality of echo trails from the storage based on a second display range set by a user, the second display range set from a plurality of predefined display ranges; and
to synthesize a display output based on the selected echo trail.

16. The system of claim 15, further comprising:
a display configured to display the display output comprising the selected echo trail.

17. The system of claim 15, further comprising:
a user interface configured to accept the second display range set by the user.

18. The system of claim 15, wherein:
the processing circuitry is further configured to process the echo information to generate the plurality of processed echo information sets for the plurality of predefined display ranges based on the received echo information.

19. The system of claim 18, wherein:
the processing circuitry is further configured to generate a processed echo information set from the received echo information for an arbitrary display range.

20. The system of claim 15, wherein:
the processing circuitry is further configured to generate a verification dataset comprising the plurality of processed echo information sets and the received echo information.
